(19) United States
(12) Patent Application Publication
(10) Pub. No.: US 2025/0129580 A1
(43) Pub. Date: Apr. 24, 2025

(54) Rectangular plastic tanks for storing rainwater and forming walls

(71) Applicant: CIRCULAR THINGS PTY LTD, Port Melbourne, VIC (AU)

(72) Inventors: Mani RIEDERICH, Victoria (AU); Alex HOFFMAN, Victoria (AU); Glenn DREW, Victoria (AU)

(21) Appl. No.: 18/693,044

(22) PCT Filed: Mar. 17, 2024
(86) PCT No.: PCT/IB2022/058793

§ 371 Date: Mar. 18, 2024

(30) Foreign Application Priority Data
Sep. 17, 2021 (AU) 2021902992

(51) Int. Cl. E03B 3/03; E04H 17/16

(52) U.S. Cl. CPC E03B 3/03; E04H 17/1602

(57) ABSTRACT

A plastic tank, comprising a substantially rectangular outer shape having top, bottom, end, and side walls, wherein the side walls comprise alternating depressions and projections, and wherein the depressions increase in depth from top to bottom to decrease internal volume of the plastic tank from top to bottom so that, in use, the side walls resist bulging under internal pressure from water stored in the plastic tank.

### FIELD

The present invention generally relates to rectangular plastic tanks for both storing rainwater and forming walls.

### BACKGROUND

Thin or slimline rectangular plastic tanks have been previously proposed for both storing rainwater collected from buildings or other structures, and for forming walls or fences adjacent to the buildings or other structures.

Existing thin rectangular plastic tanks suffer several shortcomings. The side walls of the plastic tanks bulge under internal pressure below the internal water level unless they are reinforced either by external ribbing or increased side wall thickness. External ribbing to resist bulging makes the plastic tanks visually unattractive and unsuitable for walls adjacent to buildings. Increasing side wall thickness to resist bulging increases plastic usage and cost of plastic tanks.

In view of this background, there is an unmet need for improved rectangular plastic tanks for both storing rainwater and forming walls.

### SUMMARY

According to the present invention, there is provided a plastic tank, comprising:
a substantially rectangular outer shape having top, bottom, end, and side walls;
wherein the side walls comprise alternating depressions and projections; and
wherein the depressions increase in depth from top to bottom to decrease internal volume of the plastic tank from top to bottom so that, in use, the side walls resist bulging under internal pressure from water stored in the plastic tank.

The projections may increase in height from top to bottom in proportion to the increasing depth of the depressions so that the side walls have a planer outer appearance, and the plastic tank has an outer shape that is substantially recognised as rectangular.

The depressions and projections may have a substantially constant wall thickness from top to bottom.

The depressions and projections may be concave scallops and convex scallops, respectively.

The concave and convex scallops may be arranged in parallel, vertically staggered relationship.

The side walls may comprise two pairs of vertical rebates to receive two pairs of support columns to support the plastic tank.

The top wall may comprise a pair of horizontal rebates to receive a pair of top brackets to interlock tops of the two pairs of support columns.

The plastic tank may further comprise a pair of bottom brackets to interlock bottoms of the two pairs of support columns.

The pair of bottom brackets and the bottoms of the two pairs of support columns may be set in a pair of concrete footings.

A pair of water connection ports may be provided at top and bottom of each end wall to receive rainwater in the plastic tank and overflow rainwater out of the plastic tank.

End flanges may be provided on each end wall to mount spacer panels to join the plastic tank to another plastic tank and cover the space between the two plastic tanks.

Solid internal voids may be provided between the side walls to mount wall cladding to cover the side walls of the plastic tank.

Top recesses may be provided in the pair of top brackets to mount wall accessories on top of the plastic tank.

The wall accessories may be selected from the group comprising lattice panels, water misters, sprinklers, vertical gardens, solar panels, battery storage, lighting, and sound speakers.

The present invention also provides a system for storing rainwater comprising one or more of the plastic tanks described above.

The present invention also provides a wall comprising one or more of the plastic tanks described above.

### BRIEF DESCRIPTION OF DRAWINGS

Embodiments of the invention will now be described by way of example only with reference to the accompanying drawings, in which:

FIG. 1 is a perspective view of a plastic tank according to an embodiment of the present invention;

FIG. 2 is a side view of the plastic tank;

FIG. 3 is a bottom view of the plastic tank;

FIG. 4 is a top view of the plastic tank;

FIG. 5 is an end view of the plastic tank;

FIG. 6 is a cross section view taken along section line A-A in FIG. 2;

FIG. 7 is a partial detail view of a support structure for the plastic tank;

FIG. 8 is a partially exploded perspective view of the plastic tanks forming a wall system; and

FIG. 9 is a schematic diagram of the plastic tanks forming a rainwater storage system.

### DESCRIPTION OF EMBODIMENTS

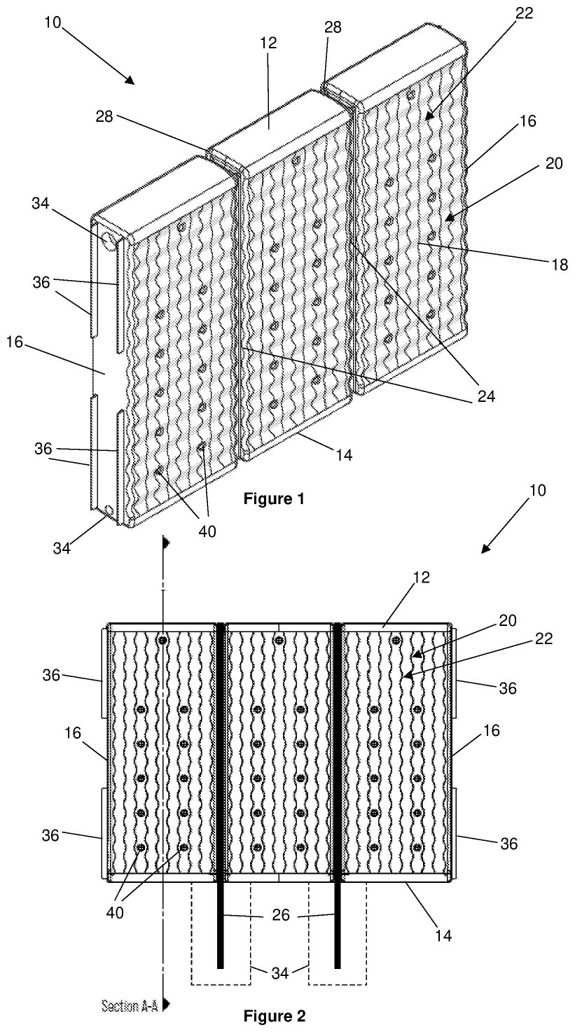

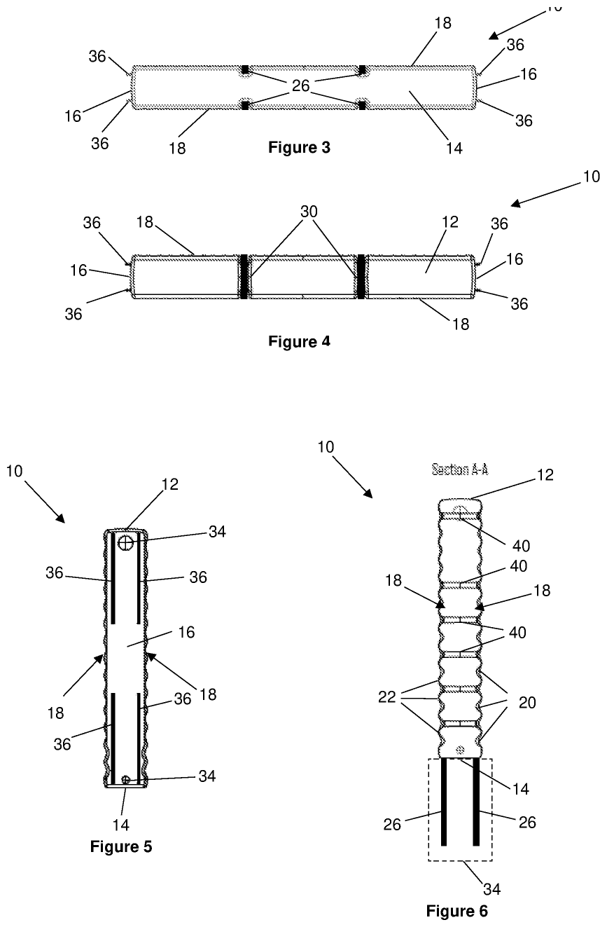

Referring to FIGS. 1 to 6, a plastic tank 10 according to an embodiment of the present invention may generally comprise a substantially rectangular outer shape having top 12, bottom 14, end 16, and side walls 18. The side walls 18 may comprise alternating depressions 20 and projections 22.

As best seen in FIG. 6, the depressions 20 may increase in depth from top to bottom to decrease internal volume of the plastic tank 10 from top to bottom so that, in use, the side walls 18 resist bulging under internal pressure from water stored in the plastic tank 10.

The projections 22 may increase in height from top to bottom in proportion to the increasing depth of the depressions 20 so that the side walls 18 have a planer outer appearance, and the plastic tank 10 has an outer shape that is substantially recognised as rectangular.

The alternating depressions 20 and projections 22 may have a visual appearance that is not unattractive. The depressions 20 and projections 22 may have a substantially constant wall thickness from top to bottom. The depressions 20 and projections 22 may, for example, be concave scallops 20 and convex scallops 22, respectively. The concave and convex scallops 20, 22 may be arranged in parallel, vertically staggered relationship.

The side walls 18 may comprise two pairs of vertical rebates 24 to receive two pairs of support columns 26 to support the plastic tank 10. The top wall 12 may comprise a pair of horizontal rebates 28 to receive a pair of top brackets 30 to interlock into tops of the two pairs of support columns 26.

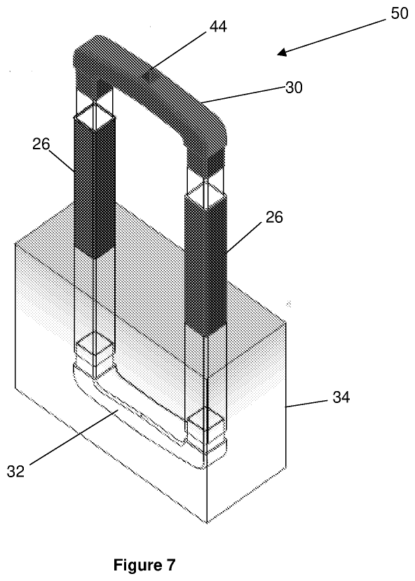

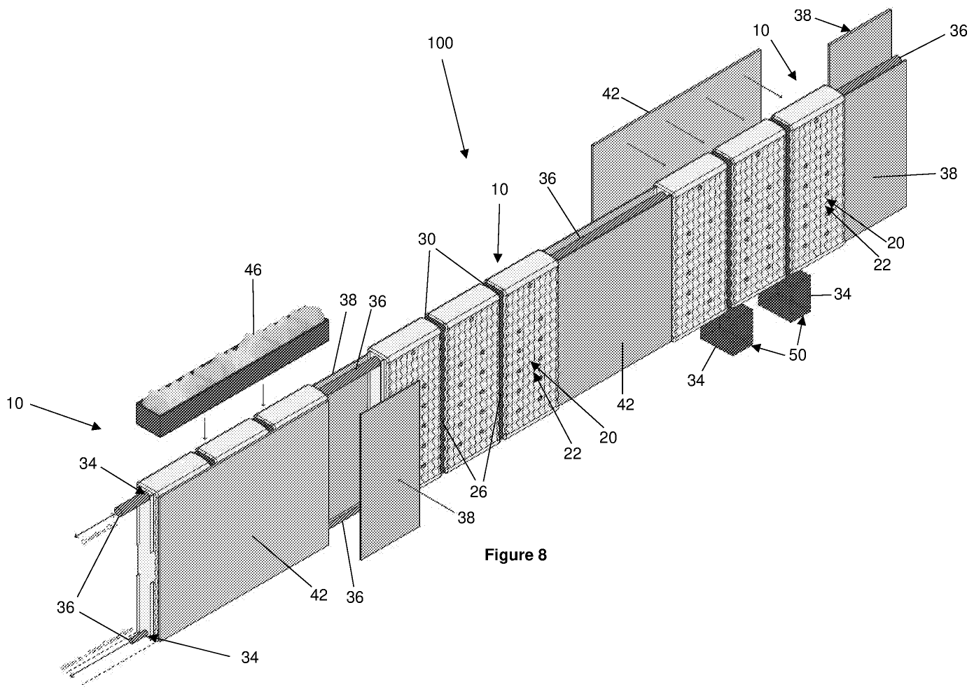

Referring to FIGS. 7 and 8, the plastic tank 10 may further comprise a pair of bottom brackets 32 to interlock bottoms of the two pairs of support columns 26. The pair of bottom brackets 32 and the bottoms of the two pairs of support columns 26 may be set in a pair of concrete footings 34. As shown in FIG. 7, the concrete footings 34, top and bottom brackets 30, 32, and the support columns 26 may collectively form a support structure 50 for the plastic tank 10. The support columns 26, and the top and bottom brackets 30, 32 may be provided together with the plastic tank 10 as a kit of parts.

A pair of water connection ports 34 may be provided at top and bottom of each end wall 16 to connect to a pair of water pipes 36 to receive rainwater in the plastic tank 10 and overflow rainwater out of the plastic tank 10. End flanges 36 may be provided on each end wall 16 to mount spacer panels 38 to join the plastic tank 10 to another plastic tank 10 and cover the pair of water pipes 36 and the space between the two plastic tanks 10. The end flanges 36 may be formed as top and bottom pairs of end flanges 36 on each end wall 16.

As best seen in FIG. 6, solid internal voids 40 may be provided between the side walls 18 to mount wall cladding 42 to cover the side walls of the plastic tank 10. Referring again to FIG. 8, top recesses 44 may be provided in the pair of top brackets 30 to mount wall accessories 46 on top of the plastic tank 10. The wall accessories 46 may, for example, comprise one or more accessories selected from the group comprising lattice panels, water misters, sprinklers, vertical gardens, solar panels, battery storage, lighting, and sound speakers. For example, the wall accessory 46 shown in FIG. 7 comprises a food garden.

The plastic tank 10, and the top and bottom brackets 30, 32, may be formed as mouldings in plastics material, such as polyethylene. The plastics material may be wholly or partially recycled. The support columns 26 may be tubular posts of metal, such as steel.

The following Examples are intended to illustrate the invention when used as both a wall system and a rainwater storage system. They are not intended to limit the scope of the invention.

### Example 1—Wall System

FIGS. 7 and 8 show an example wall system 100 formed as a boundary wall or fence from multiple plastic tanks 10. In this example, the wall system 100 is implemented as a modular six-part system 100 comprising the plastic tanks 10, on-wall cladding 42, spacer panels 38, on-wall accessories 46, support structures 50, and water connections 36.

The wall system 100 may be fully customised to fit a variety of landscapes and terrains, allowing the system 48 to be deployed across a greater region of land types and scenarios. Outlined below are examples of each of the five additional parts 42, 38, 46, 50, 36 of the system 100, and examples of their features and functionality.

### On-Wall Cladding

Each plastic tank 10 of the wall system 100 may have attachment points 26 on either side wall 18 built into the form, allowing for a variety of attachments and customised finishes. By providing the possibility of cladding 42 on each plastic tank 10 comprising the wall sections, the system 100 as a whole may align with property aesthetic and surrounding amenity, integrating into the overall design thinking, regardless of whether it is a new property or fence line replacement. The cladding 42 may also create function, due to the immediate supply of water, such as vertical gardens and food growth, or water features like ponds and falling water.

The cladding 42 may be provided in several different colours, patterns, and finishes. For example, the cladding 42 may be provided with metal, timber, stone, or brick finishes. In addition, the cladding 42 may comprise functional cladding, such as solar panels.

### Spacer Panels

Two different types of spacer panels 38 may be provided in different predetermined lengths. The first type of spacer panel 38 may be made of the same recycled plastic with the same surface patterning as the plastic tanks 10 so that they can be joined and create a seamless visual aesthetic along the fence line. The second type of spacer panel 38 may be a frame that allows for the same variety of attachment possibilities as the on-wall cladding 42.

These two types of spacer panels 38 may fix onto integrated notches provided by the top and bottom pairs of flanges 36 at the end walls 16 of each wall section 10 on both outer sides. This combination of spacer panelling 38 may create a space which can be used to house plumbing and pump componentry, allowing the wall system 100 to hide all plumbing and electrical services.

### On-Wall Accessories

Traditional walls and fences have the capability to add on additional attachments to block out views from neighbouring properties or add extra functionality. The wall system 100 may allow for increased opportunity for on-wall accessories 46 as each plastic tank 10 comprising a wall section 10 has width to it, providing it with a flat surface and points of attachment. Accessories 46 may be mounted via the top notches 44 in the two top brackets 30 that secure the plastic tanks 10 and integrate them into the system 100. Examples of on-wall accessories 46 are described below.

Lattice panels may provide a versatile and varied block out solution to remove the ability for neighbours to see into a property. Each panel may be manufactured out of the same plastic as the plastic tanks 10 and may be selected from the same set of colours to enhance customisation.

Water misters or sprinklers may be attached across the wall 100 and throughout the system 100 to use the stored rainwater for watering adjacent gardens, or for fire prevention in a fire emergency to help mitigate the risk of ember attacks.

Vertical gardens, vines and garden beds may be used to grow vegetation and plants for aesthetic appeal and food. Given the location of the vegetation on the wall 100, it may be automatically watered using the rainwater stored in the plastic tanks 10.

Solar panels may be attached to both power water pumps and feed back into the building and the grid, reducing further costs to operating any surrounding infrastructure.

Other attachments, such as lighting and outdoor sound speakers may add to the atmosphere of the surrounding spaces of the wall system 100.

### Support Structure

Each plastic tank 10 of the wall section may sit on pair of support structures 50 comprising two concrete pads 34 set around the bottom bracket 32 and steel support columns 26. Each plastic tank 10 comprising a wall section may then be dropped in from the top and braced by the top brackets 30. The top brackets 30 may subsequently be detached, the plastic tank 10 removed, and a new plastic tank 10 inserted with the top brackets 30 re-attached without affecting the overall system 100.

By recessing the support structure 50 within the form of the plastic tank 10, the surface may remain flat and allow for the customisation and attachments mentioned above. The rigid support structure 50 may both support and securely hold individual plastic tanks 10 in place, and securely brace the overall system 100 and fence line as a whole.

### Water Connections

The system 100 may receive rainwater through primary plastic tanks 10 that are wall sections which are connected to downpipes of gutters, roofs, or other collection surfaces of a building or other structure. Any wall sections 10 may be designated as the primary ones along the system 100 to reduce piping requirements. All piping 36 and pumps may be hidden behind the spacer panels 38 to remove any services from view. The overflow point of discharge may be directed into a variety runoff and passive irrigation systems to reduce stormwater intake.

### Example 2—Rainwater Storage System

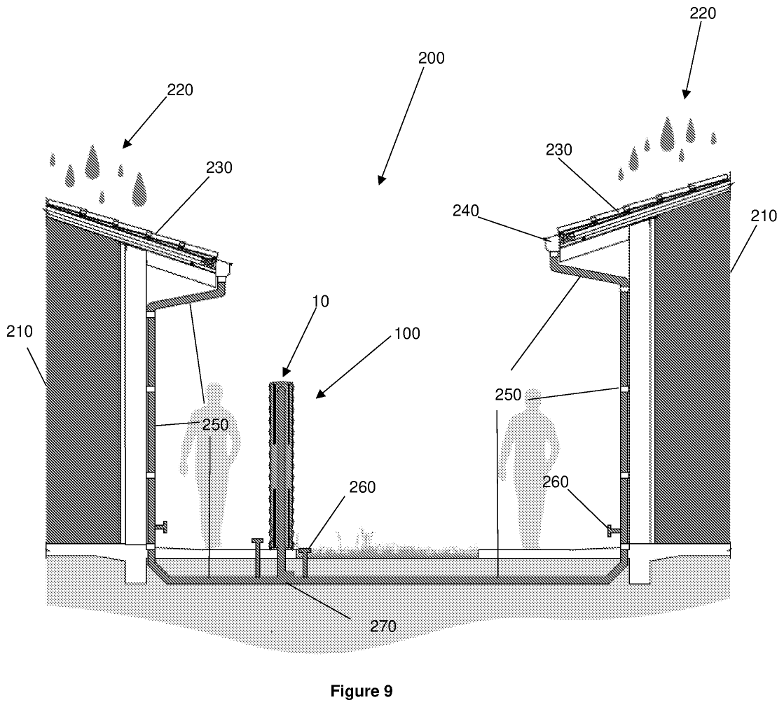

FIG. 9 shows an example rainwater storage system 200 using the wall system 100 described in Example 1 installed as a boundary wall between two adjacent buildings 210.

Rainwater 220 landing on roofs 230 may be piped through to the primary intake plastic tank 10 or wall section of the system 100 and stored in the plastic tanks 10. Pumps may then manage rainwater distribution for re-use. Once all wall sections 10 are full, excess rainwater may overflow into secondary systems such as natural filtration, wetlands, public storage, or storm water drainage.

Roof catchments 230 may channel water to roof gutters 240. The roof gutters 240 may have full mesh covering to ensure bugs and debris do not enter the downpipe system and may also contain a strainer for high volume rainfall. Downpipes and connection pipes 250 may have equivalent sizing to the outflow pipe 250 of the gutter 240.

Inspection points 260 may be located at the base of the downpipes 250 and close to the connection pipe 250. These may allow for cleaning and maintenance in areas of likely debris blockages.

For scenarios where stored rainwater is shared across boundaries between adjacent buildings 210, smart sensors and controllers 270 may be connected to the wall sections 10 to allow for monitoring and controlling water usage on either side of the boundary.

Rainwater 220 may enter the primary wall sections 10 via a gravity fed system, which may only require a 300 mm static head from the base of the gutter 240 to the top of the wall section 10 to allow rainwater 220 to flow in naturally without the need for pumps or overhead piping.

Embodiments of the present invention provide a plastic tank that is both generally and specifically useful for both storing rainwater and forming walls.

Unless the context requires otherwise, the word “comprising” means “including but not limited to,” and the word “comprises” has a corresponding meaning.

Any reference to prior art is not an admission that the prior art is common general knowledge.

The scope of the invention supported by the above examples is defined by the claims that follow.

1. A plastic tank, comprising:
a substantially rectangular outer shape having top, bottom, end, and side walls;
wherein the side walls comprise alternating depressions and projections; and
wherein the depressions increase in depth from top to bottom to decrease internal volume of the plastic tank from top to bottom so that, in use, the side walls resist bulging under internal pressure from water stored in the plastic tank.

2. The plastic tank of claim 1, wherein the projections increase in height from top to bottom in proportion to the increasing depth of the depressions so that the side walls have a planer outer appearance, and the plastic tank has an outer shape that is substantially recognised as rectangular.

3. The plastic tank of claim 1, wherein the depressions and projections have a substantially constant wall thickness from top to bottom.

4. The plastic tank of claim 1, wherein the depressions and projections comprise concave scallops and convex scallops, respectively.

5. The plastic tank of claim 4, wherein the concave and convex scallops are arranged in parallel, vertically staggered relationship.

6. The plastic tank of claim 1, wherein the side walls comprise two pairs of vertical rebates to receive two pairs of support columns to support the plastic tank.

7. The plastic tank of claim 6, wherein the top wall comprises a pair of horizontal rebates to receive a pair of top brackets to interlock tops of the two pairs of support columns.

8. The plastic tank of claim 7, further comprising a pair of bottom brackets to interlock bottoms of the two pairs of support columns.

9. The plastic tank of claim 8, wherein the pair of bottom brackets and the bottoms of the two pairs of support columns are set in a pair of concrete footings.

10. The plastic tank of claim 1, wherein a pair of water connection ports is provided at top and bottom of each end wall to receive rainwater in the plastic tank and overflow rainwater out of the plastic tank.

11. The plastic tank of claim 1, wherein end flanges are provided on each end wall to mount spacer panels to join the plastic tank to another plastic tank and cover space between the two plastic tanks.

12. The plastic tank of claim 1, wherein solid internal voids are provided between the side walls to mount wall cladding to cover the side walls of the plastic tank.

13. The plastic tank of claim 7, wherein top recesses are provided in the pair of top brackets to mount wall accessories on top of the plastic tank.

14. The plastic tank of claim 13, wherein the wall accessories are selected from the group comprising lattice panels, water misters, sprinklers, vertical gardens, solar panels, battery storage, lighting, and sound speakers.

15. A system for storing rainwater comprising one or more of the plastic tanks of claim 1.

16. A wall comprising one or more of the plastic tanks of claim 1.
